(19) United States
(12) Patent Application Publication
(10) Pub. No.: US 2010/0302463 A1
(43) Pub. Date: Dec. 2, 2010

(54) PROJECTION VIDEO DISPLAY DEVICE

(75) Inventor: Shinya Matsumoto, Hirakata City (JP)

Correspondence Address: MOTS LAW, PLLC, 1629 K STREET N.W., SUITE 602, WASHINGTON, DC, 20006-1635, US

(73) Assignee: SANYO ELECTRIC CO., LTD., Moriguchi City (JP)

(21) Appl. No.: 12/472,475

(22) Filed: May 27, 2009

(51) Int. Cl. H04N 9/31

(52) U.S. Cl. 348/744; 348/E09.025

(57) ABSTRACT

A projection video display device 100 includes: a first housing 101 that houses a laser light source 1 and an optical modulation unit 2 that modulates laser light and generates video image light; a second housing 102 that houses a refrigerant circuit 4 to which a compressor, a heat radiator, an expansion valve, and a heat absorber are connected via a refrigerant piping; and air blower portions F2, F3 that send out air in the first housing 101 into the second housing 102 to perform heat exchange with the heat absorber and send out the air that undergoes the heat exchange with the heat absorber into the first housing 101.

### BACKGROUND OF THE INVENTION

1. Field of the Invention

The present invention relates to a projection video display device that projects video image light onto a screen to display a video image on the screen. More particularly, the present invention relates to a projection video display device that includes a semiconductor laser as a light source.

2. Description of Related Art

In recent years, in a projection video display device, it has been proposed to use a high-power semiconductor laser as a light source. On the other hand, because a semiconductor laser decreases in output power and life when temperature of the semiconductor laser rises, it is necessary to perform temperature control.

To solve the above described problem, various devices and methods have been proposed. For example, a video display device is disclosed, in which temperature of a semiconductor laser is detected; a driving current is flown through a Peltier element in accordance with a signal that depends on difference between the detected temperature and predetermined temperature (for example, 25° C.); thus, feedback control is performed to maintain the temperature of the semiconductor laser at the predetermined temperature (See, JP-A-2004-356579).

However, in conventional projection video display devices such as the above video display device and the like, although it is possible to control the temperature of the semiconductor laser, there is a possibility that moisture condensation is caused by cooling the semiconductor laser, and the output power and life decrease. In other words, if water drops attach to the semiconductor laser and laser light emitted from the semiconductor laser enters the attaching water drops, light energy of the laser light is transduced into thermal energy and the output power and life of the laser decrease (the performance deteriorates).

### SUMMARY OF THE INVENTION

The present invention has been made to deal with the above described problems, and it is an object of the present invention to provide a projection video display device that is able to surely prevent performance deterioration of a laser light source from occurring with simple structure.

To achieve the above object, a projection video display device according to a first aspect of the present invention includes: a projection video generation portion that has a laser light source and an optical modulation unit that modulates light from the laser light source and generates video image light; a first housing that houses the projection video generation portion; and an air conditioning portion that has a dehumidification function to dehumidify air in the first housing.

Here, dehumidification means to decrease absolute amount of moisture that is included in air. According to such a projection video display device, it is possible to prevent performance deterioration of the laser light source because moisture condensation does not occur even if the laser light source is cooled.

In the above projection video display device, it is desirable that a second housing that houses the air conditioning portion is further included, and the second housing is disposed below the first housing. According to this, even if a refrigerant or lubricating oil leaks from the air conditioning portion, it is possible to prevent the refrigerant and the lubricating oil from flowing down to the laser light source and the like and to reduce causes of trouble of the laser light source. Besides, it is desirable that the air conditioning portion has a cooling function to cool the air in the first housing. According to this, it is possible to lower temperature in the first housing in which the laser light source is housed and to easily control the temperature of the laser light source. Further, it is desirable to include a cooling portion that liquid-cools the projection video generation portion. According to this, it is possible to curb noise low compared with an air-cooling type cooling portion and to efficiently cool the projection video generation portion that includes the laser light source.

A projection video display device according to a second aspect of the present invention includes: a projection video generation portion that has a laser light source and an optical modulation unit that modulates light from the laser light source and generates video image light; a first housing that houses the projection video generation portion; a refrigerant circuit to which a compressor, a heat radiator, an expansion valve, and a heat absorber are connected via a refrigerant piping; a second housing that houses the refrigerant circuit; and an air blower portion that sends out air in the first housing into the second housing to perform heat exchange with the heat absorber and sends out the air that undergoes the heat exchange with the heat absorber into the first housing.

According to this projection video display device, because air in the first housing in which the laser light source is housed, is taken into the second housing and the air heat is exchanged with the heat absorber in the second housing, it is possible to condense moisture in the air and to remove the condensed moisture. And, it is possible to decrease the moisture amount in the first housing by returning the moisture-removed air into the first housing. Here, if the air to be returned into the first housing is made undergo a heat exchange with the heat radiator in the second housing, the temperature in the first housing is able to be maintained at a constant value; if the air is retuned into the first housing without undergoing the heat exchange with the heat radiator, the temperature in the first housing is able to be lowered. In other words, it is possible to efficiently dehumidify and cool the air in the first housing with a simple structure.

A method for starting a projection video display device according to a third aspect of the present invention includes: a projection video generation portion that has a laser light source and an optical modulation unit that modulates light from the laser light source and generates video image light; and a first housing that houses the projection video generation portion, wherein the projection video display device, further comprising: a first detection portion that detects temperature or humidity in the first housing; and an air conditioning portion that has a function to dehumidify air in the first housing, and wherein starts of the air conditioning portion and the projection video generation portion are controlled based on detection result from the first detection portion.

According to this method for starting a projection video display device, for example, if it is determined from result detected by the first detection portion that the air humidity in the first housing is high, it is possible to prevent performance deterioration of the laser light source due to moisture condensation from occurring by dehumidifying with the air conditioning portion and then by starting the projection video generation portion.

Specifically, in the method for starting the above projection video display device, it is desirable to include: a dehumidification step of operating the dehumidification function of the air conditioning portion for operation time that is set based on detection result detected by the first detection portion; and a projection step of starting the projection video generation portion after the dehumidification step is completed. According to this, because the dehumidification is performed based on the preset operation time, control of the start operation is able to be easily achieved. Besides, it is desirable that the projection video display device further includes a second detection portion that detects temperature of the laser light source; and a cooling portion that liquid-cools the projection video generation portion, wherein the method further comprising a cooling step of starting the cooling portion if the temperature detected by the second detection portion is equal to or lower than a first preset threshold temperature. For example, if it is determined by the second detection portion that the temperature of the laser light source is high, the amount of saturated water vapor around the laser light source is high, and there is a possibility that moisture condensation occurs on the laser light source when the cooling portion is started. In contrast, if the temperature of the laser light source is equal to or lower than a predetermined threshold value, it is less possible that moisture condensation occurs even if the cooling portion is started to cool the laser light source. In other words, it is possible to prevent performance deterioration of the laser light source due to moisture condensation from occurring with a simple structure.

According to the present invention, with a simple structure, it is possible to prevent moisture condensation at the time of cooling the temperature of the laser light source to the operation temperature and to prevent performance deterioration of the laser light source from occurring.

### DESCRIPTION OF THE DRAWINGS

FIG. 1 is a side structural view to show an example of structure of a liquid crystal projector according the present invention.

FIG. 2 is a plan structural view to show an example of each structure of a laser light source, an optical modulation unit and an arrangement position of a sensor.

FIG. 3 is a plan structural view to show an example of detailed structure of an optical modulation unit.

FIG. 4 is a block diagram to show an example of functional structure of a CPU.

FIG. 5 is a flow chart to show an example of operation of the liquid crystal projector (mainly the CPU).

FIG. 6 is a flow chart to show an example of operation of the liquid crystal projector (mainly the CPU).

FIG. 7 is a side structural view to show an example of another structure different from the liquid crystal projector in FIG. 1 according to the present invention.

FIG. 8 is a plan structural view to show an example of another structure different from the laser light source in FIG. 2.

### DETAILED DESCRIPTION OF PREFERRED EMBODIMENTS

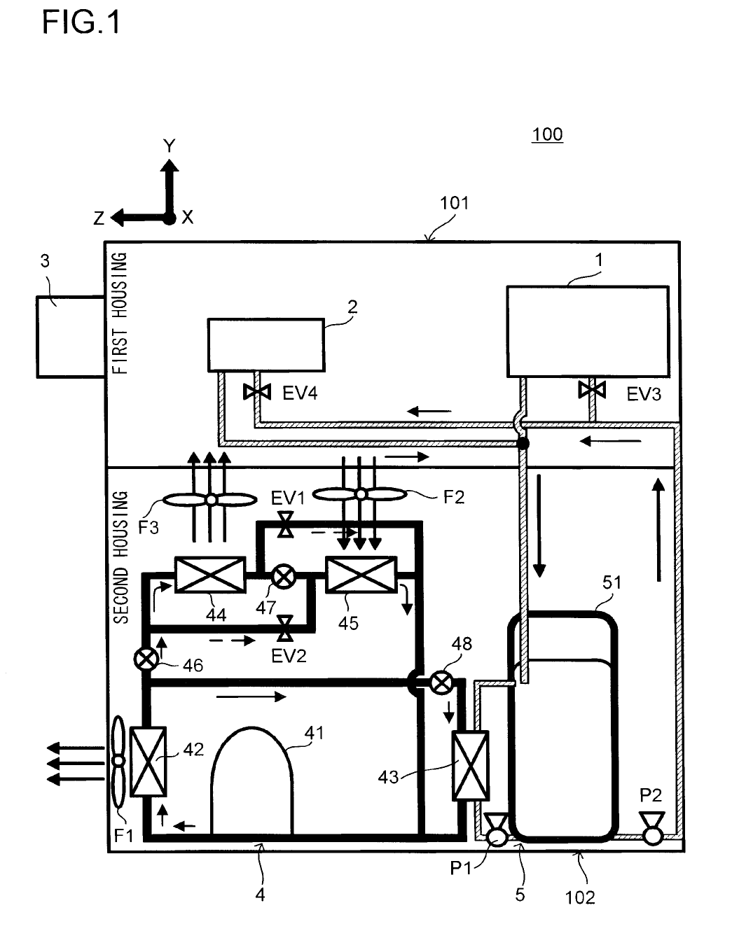

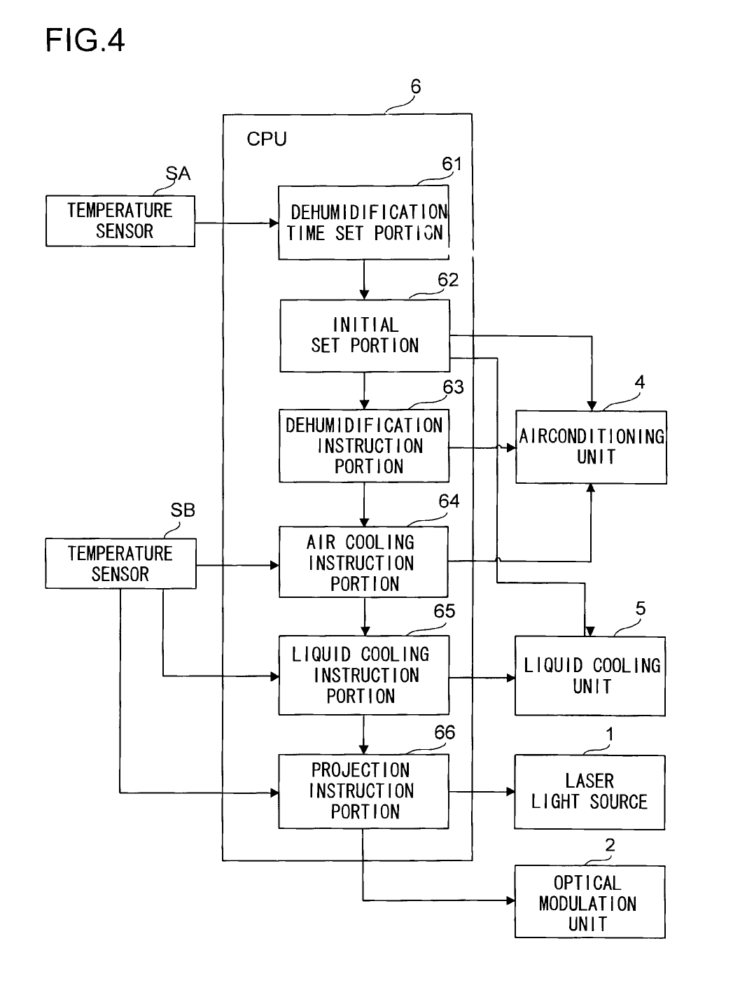

Hereinafter, embodiments of the present invention will be explained with reference to the drawings. FIG. 1 is a side structural view to show one example of structure for a liquid crystal projector according the present invention. In FIG. 1, X-axis is set in a direction toward a point over the paper surface, Y-axis is set in an upward direction of the drawing, and the Z-axis is set in a leftward direction of the drawing. The X-Z plane is a plane substantially parallel to a plane on which the projector is placed. A liquid crystal projector (which corresponds to a projection video display device) 100 includes a first housing 101 and a second housing 102. The first housing 101 houses a laser light source 1 and an optical modulation unit 2, and a projection optical unit 3 is disposed on a left-side surface of the first housing 101. The second housing 102 is disposed under the first housing 101, and houses an air conditioning unit 4 and a liquid cooling unit 5. The liquid crystal projector 100 also includes a CPU (See FIG. 4) which is not shown in FIG. 1 at an appropriate position.

The laser light source 1 (which corresponds to a part of a projection video generation portion) includes semiconductor lasers and the like, and emits laser lights that correspond to three primary colors of R (red), G (green), and B (blue) to the optical modulation unit 2. The optical modulation unit 2 (which corresponds to a part of the projection video generation portion) modulates the laser lights that correspond to the 3 primary colors from the laser light source 1, generates video image light and emits the video image light to the projection optical unit 3. The projection optical unit 3 projects the video image light from the optical modulation unit 2 onto a screen which is not shown in the drawing.

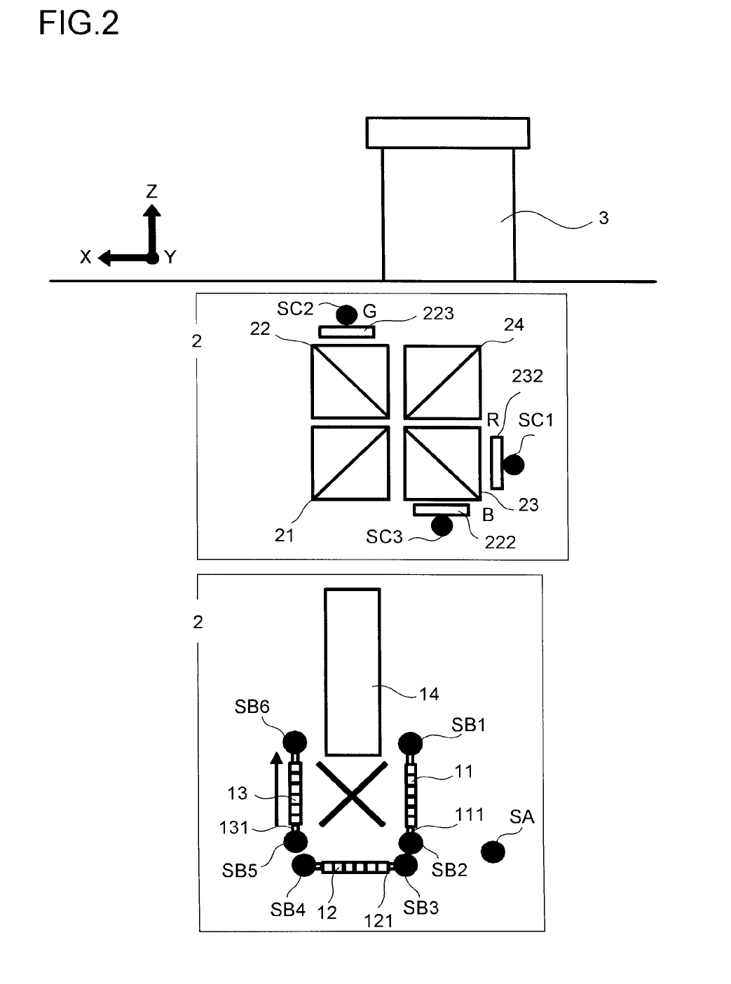

FIG. 2 is a plan structural view to show examples of each structure of the laser light source 1 and the optical modulation unit 2. In FIG. 2, the X-axis is set in a left direction in the drawing, the Y-axis is set in a direction toward a point over the paper surface, and the Z-axis is set in an upward direction. The X-Z plane is a plane substantially parallel to the plane on which the projector is placed. The laser light source 1 includes laser arrays 11, 12, 13 and a light guide portion 14.

The laser arrays 11, 12 and 13 are each composed of a plurality of semiconductor lasers which are arranged two-dimensionally and emit the R (red)-color, G (green)-color and B (blue)-color laser lights. To cool the semiconductor lasers, cooling water piping 111, 121 and 131 from the liquid cooling unit 5 are arranged. The light guide portion 14 guides the laser lights emitted from the laser arrays 11, 12 and 13 to the optical modulation unit 2. Here, when arranging the semiconductor lasers, the semiconductor lasers are so arranged that the laser light, that is, the R light, the G light and the B light emitted from the laser arrays 11, 12 and 13 become S-polarized light, P-polarized light and S-polarized light, respectively.

The optical modulation unit 2 modulates the laser lights of the 3 primary colors from the laser light source 1 in accordance with a video image, generates video image light, emits the video image light to the projection optical unit 3, includes: polarization beam splitters (PBSs) 21, 22, 23, 24; liquid crystal panels 222, 223, 232 and the like corresponding to the 3 primary colors. The video image light produced by the PBS 24 is emitted to the projection optical unit 3.

Besides, in the first housing 101 in which the laser light source 1 and the optical modulation unit 2 are housed, a temperature sensor SA is disposed near the laser light source 1; temperature sensors SB are disposed in a cooling water piping of the laser light source 1; and temperature sensors SC are disposed on rear sides of the liquid crystal panels 222, 223 and 232 that are disposed in the optical modulation unit 2. The temperature sensor SA (which corresponds to a first detection portion) includes a thermistor and the like, and detects air temperature in the first housing 101. The temperature sensors SB (which correspond to a second detection portion) include 6 temperature sensors SB1 to SB6 which have a thermistor and the like and are disposed in upstream sides and downstream sides of the cooling water piping of the laser arrays 11, 12 and 13, and detect temperature TA of the laser light source 1. The temperature sensors SC include 3 temperature sensors SC1 to SC3 which have a thermistor and the like and are respectively disposed on the rear sides of the liquid crystal panels 222, 223 and 232 that are disposed in the optical modulation unit 2; and detect temperature TB of the laser light source 1.

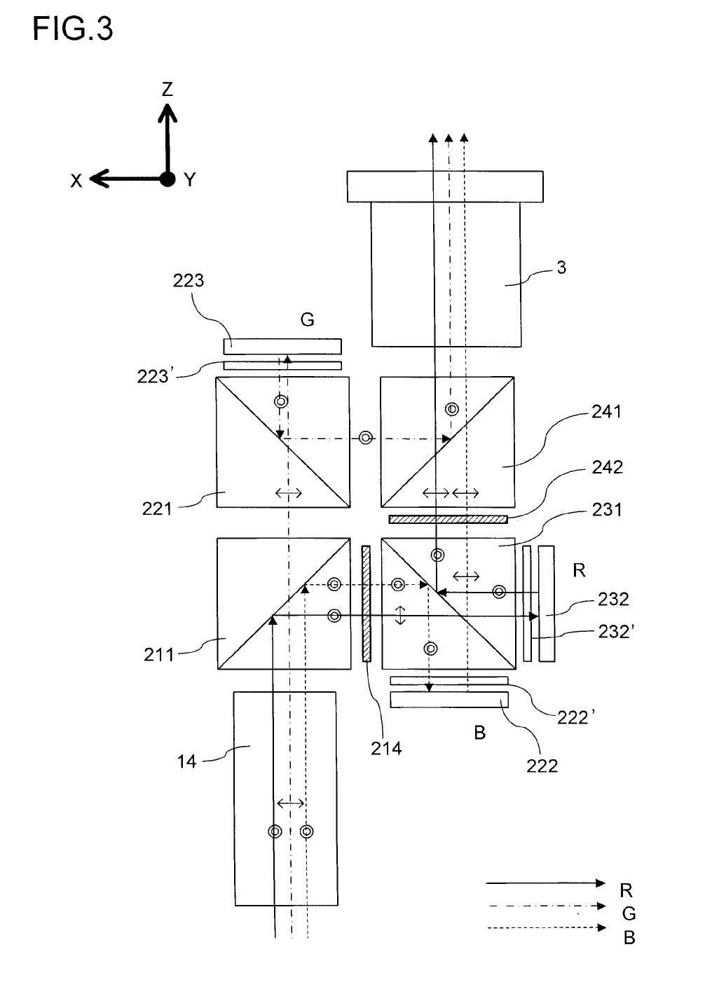

FIG. 3 is plan structural view to show an example of a detailed structure of the optical modulation unit 2. The light emitted from the light guide portion 14 includes the R light as the S-polarized light, the G light as the P-polarized light, and the B light as the S-polarized light with respect to a polarization surface of the PBS 211. Accordingly, the G light passes through the PBS 211 the B and R light is reflected by the PBS 211. The R light of the B light and the R light reflected by the PBS 211 is converted into the P-polarized light by a half wave plate 214. Besides, the B light of the B light and the R light is reflected by the PBS 231 and the R light passes through the PBS 231.

The B light reflected by the PBS 231 is converted into circularly polarized light by a quarter wave plate 222′, then enters the reflection type liquid crystal panel 222. Here, the B light reciprocates in the liquid crystal panel 222 and, for example, the rotation direction of the circularly polarized light is inversed at only a pixel position that is in an on state. Accordingly, the B light passes through the quarter wave plate 222′ again, thus the B light turns into the P-polarized light at a pixel position that is in the on state and into the S-polarized light at a pixel position that is in an off state. Only the P-polarized light at the on-state pixel position passes through the PBS 231 and enters the PBS 241 via a half wave plate 242 that is wavelength-selective to the R light.

Likewise, the R light that passes through the PBS 231 after passing through the half wave plate 214 reciprocates in a quarter wave plate 232′ and a liquid crystal panel 232, thus only the part of the R light that corresponds to the on-state pixel position is reflected by the PBS 231 and is guided to the half wave plate 242 that is wavelength-selective. The R light is converted into the P-polarized light by the half wave plate 242 that is wavelength-selective and then enters the PBS 241. Thus, the B and R lights that are modulated by the liquid crystal panels 222, 232 enter the PBS 241 together as the same P-polarized lights.

The G light that passes through the PBS 211 passes through the PBS 221, then reciprocates in a quarter wave plate 223′ and a reflection type liquid crystal panel 223, thus only the part that corresponds to the on-state pixel position is reflected by the PBS 221 and enters the PBS 241. Because the G light enters the PBS 241 as the S-polarized light, the G light is reflected by the PBS 241.

As described above, the B, G and R lights reflected by the liquid crystal panels 222, 223 and 232 are combined when passing through the PBS 241, turns into color video image light and is emitted to the projection optical unit 3.

The air conditioning unit 4 and the liquid cooling unit 5 that, with a simple structure, are capable of cooling the liquid crystal projector 100 that includes the above laser light source 1 and the optical modulation unit 2 are described in detail below.

[First Embodiment] Back to FIG. 1, the air conditioning unit 4 (which corresponds to an air conditioning portion) has a dehumidification function to dehumidify the air in the first housing 101 and an air cooling function to cool the air in the first housing 101, and includes: a compressor 41; heat exchangers 42, 43, 44, 45; expansion valves 46, 47, 48; solenoid valves EVE, EV2; and fans F1, F2 and F3.

The compressor 41 (which corresponds to a part of a refrigerant circuit) compresses a refrigerant (e.g., R134a, R744 and the like) and sends out the refrigerant from a lower side on a left side in FIG. 1 into the heat exchanger 42 that is connected to the compressor 41 via a refrigerant piping.

The heat exchanger 42 (which corresponds to a part of the refrigerant circuit) functions as a heat radiator that cools the refrigerant. Near the heat exchanger 42, the fan F1 that sends out the air in the second housing 102 which is heat-exchanged by the heat exchanger 42 to the outside is disposed. To a downstream side of the heat exchanger 42, the heat exchanger 44 is connected via the expansion valve 46 and the heat exchanger 43 is connected via the expansion valve 48. The refrigerant cooled (condensed) by the heat exchanger 42 flows into the heat exchanger 44 via the expansion valve 46.

The heat exchanger 45 is connected to a downstream side of the heat exchanger 44 via the expansion valve 47, and a downstream side of the heat exchanger 45 is connected to an inlet side of the compressor 41. The expansion valve 46 is connected to an upstream side of the heat exchanger 45 via the solenoid valve EV2, and the downstream side of the heat exchanger 44 is connected to the inlet side of the compressor 41 via the solenoid valve EV1. Likewise, a downstream side of the heat exchanger 43 is connected to the inlet side of the compressor 41.

The fan F3 is disposed near (here, the upside) the heat exchanger 44. The fan F3 (which corresponds to a part of an air blower portion) sends out the air in the second housing 102 which is heat-exchanged (heated or cooled) by the heat exchanger 44 into the first housing 101. The fan F2 is disposed near (here, the upside) the hear exchanger 45. The fan F2 (which corresponds to a part of the air blower portion) inhales the air in the first housing 101 into the second housing 102 to heat-exchange the air by the heat exchanger 45.

The expansion valves 46, 47 and the solenoid valves EV1, EV2 are so switched as to force the fans F2, F3 and the heat exchangers 44, 45 to perform either one of the dehumidification function to dehumidify the air in the first housing 101 and the air cooling function to cool the air in the first housing 101. The switching of the expansion valves 46, 47 and the solenoid valves EV1, EV2 is performed in accordance with an instruction from a CPU 6 which will be described later. Here, the heat exchanger 45 corresponds to a first heat exchanger and the heat exchanger 44 corresponds to a second heat exchanger.

First, a case in which the air conditioning unit 4 is forced to perform the dehumidification function is described. The solenoid valves EV1 and EV2 are closed, and the heat exchanger 44 and the heat exchanger 45 are connected in series with each other; the expansion valve 46 is turned off (a state in which the valve is fully opened and does not function as an expansion valve) and the expansion valve 47 is turned on (a state in which the valve is opened and functions as an expansion valve); thus, the heat exchanger 44 is forced to function as a heat radiator and the heat exchanger 45 is forced to function as a heat absorber. In this state, the air in the first housing 101 that is inhaled by the fan F2 is cooled by the heat exchanger 45 and the moisture is condensed and removed. And the air is heated to a normal temperature by the heat exchanger 44 and is returned into the first housing 101 by the fan F3. The air flow is circulated and the air in the first housing 101 is dehumidified.

Next, a case in which the air conditioning unit 4 is forced to perform the cooling function is described. The solenoid valves EV1, EV2 are opened, and the expansion valve 47 is closed; thus, the heat exchanger 44 and the heat exchanger 45 are connected in parallel with each other; the expansion valve 46 is turned on (a state in which the valve is opened and functions as an expansion valve); thus, the heat exchanger 44 and the heat exchanger 45 are forced to function as heat absorbers. In this state, the air in the first housing 101 that is inhaled by the fan F2 is cooled by the heat exchangers 45, 44 and returned into the first housing 101 by the fan F3. Thus, the air in the housing 101 is cooled.

When the expansion valve 48 is turned on (a state in which the valve is opened and functions as an expansion valve) in accordance with an instruction from the CPU 6 which will be described later, the heat exchanger 43 (which corresponds to a third heat exchanger) functions as a heat absorber and cools the cooling water that is a heat carry medium of the liquid cooling unit 5. Here, in this embodiment, it is described that the liquid cooling unit that uses water (cooling water) as the heat carry medium. However, a fluid may be used as the heat carry medium, and for example, ethanol or glycol may be used in accordance with a temperature range of the carried heat and environmental temperature in which the liquid crystal projector 100 is disposed.

The liquid cooling unit 5 (which corresponds to a cooling portion) cools the laser light source 1 and the optical modulation unit 2 by a liquid cooling method (water cooling method in this embodiment), and includes: a water storage tank 51; pumps P1, P2; and solenoid valves EV3, and EV4.

The water storage tank 51 stores the cooling water that functions as the heat carry medium. The pump P1 sends out the cooling water of the water storage tank 51 to the heat exchanger 43. The pump P2 sends out the cooling water of the water storage tank 51 to the laser light source 1 and the optical modulation unit 2. The solenoid valves EV3, EV4 are opened to cool the laser light source 1 and the optical modulation unit 2, respectively. Besides, the solenoid valve EV3 is connected to the cooling water piping 111, 121, and 131 in FIG. 2.

FIG. 4 is a block diagram to show an example of a functional structure of the CPU 6. The CPU (Central Processing Unit) 6 (which corresponds to a start control portion) of the liquid crystal projector 100 controls operation of the entire liquid crystal projector 100 and includes: a dehumidification time set portion 61; an initial set portion 62; a dehumidification instruction portion 63; an air cooling instruction portion 64; a liquid cooling instruction portion 65; and a projection instruction portion 66 as software in this embodiment. Especially, the CPU 6 controls operation of the laser light source 1, the optical modulation unit 2, the air conditioning unit 4 and the liquid cooling unit 5 based on detection results from the temperature sensor SA and the temperature sensor SB. The CPU 6 functions as functional portions of: the dehumidification time set portion 61; the initial set portion 62; the dehumidification instruction portion 63; the air cooling instruction portion 64; the liquid cooling instruction portion 65; the projection instruction portion 66 and the like by executing a control program that is stored in a not-shown ROM (Read Only Memory) and the like in advance.

Besides, of various kinds of data that are stored in a not-shown RAM (Random Access Memory), a ROM and the like, data that are able to be stored in a removable recording medium may be made readable by drivers such as, for example, a hard disk drive, an optical disc drive, a flexible disk drive, a silicon disc drive, a cassette medium reader and the like. The recording medium is, for example, a hard disk, an optical disc, a flexible disk, a CD (Compact Disc), a DVD (Digital Versatile Disc), a semiconductor memory and the like.

The dehumidification time set portion 61 determines whether or not a power source is turned on, and if the power source is turned on, sets an operation time T1 for the dehumidification function of the air conditioning unit 4 based on the air temperature TA in the first housing 101 detected by the temperature sensor SA. Specifically, the operation time T1 for the dehumidification function is stored in a not-shown RAM and the like corresponding to the temperature TA in advance; the dehumidification time set portion 61 sets the operation time T1 by reading the operation time T1 from the RAM or the like that corresponds to the air temperature TA in the first housing 101 that is detected by the temperature sensor SA at the time of turning on the power source.

If it is determined by the dehumidification time set portion 61 that the power source is turned on, the initial set portion 62 starts the refrigerant circuit of the air conditioning unit 4, the compressor 41, the fans F1 to F3 (See FIG. 1) and begins temperature control of the cooling water in the water storage tank 51 (See FIG. 1) of the cooled-water unit 5.

Here, the temperature TW of the cooling water stored in the water storage tank 51 of the liquid cooling unit 5 is detected by a temperature sensor (not shown) disposed in the water storage tank 51; if the temperature TW is equal to or higher than a preset threshold value (e.g., 10° C.), the expansion valve 48 is turned on and the pump PI is started, thus the cooling water is cooled via the heat exchanger 43 and the temperature TW is controlled.

From the time the power source is turned on, the dehumidification instruction portion 63 forces the dehumidification function of the air conditioning unit 4 to operate for the operation time T1 that is set by the dehumidification time set portion 61. Specifically, from the time the power source is turned on, the dehumidification instruction portion 63 puts the solenoid valves EV1, EV2 into the closed state, turns off the expansion valve 46, turns on the expansion valve 47, thus forces the air conditioning unit 4 to perform the dehumidification function for the operation time T1 that is set by the dehumidification time set portion 61 (See FIG. 1).

After the dehumidification function of the air conditioning unit 4 is performed for the operation time T1 by the dehumidification instruction portion 63, the air cooling instruction portion 64 keeps the cooling function of the air conditioning unit 4 operating until the temperature TB detected by the temperature sensor SB reaches a preset first threshold temperature SH1 (e.g., 20° C.) or lower.

As shown in FIG. 2, because the temperature sensors SB includes the 6 temperature sensors SB1 to SB6, the highest temperature of the temperatures detected by the 6 temperature sensors SB1 to SB6 is used as the temperature TB that is used by the air cooling instruction portion 64, the liquid cooling instruction portion 65 and the projection instruction portion 66 for control. Besides, until the temperature TB reaches the preset first threshold temperature SH1 or lower, the air cooling instruction portion 64 keeps the solenoid valves EV1, EV2 in the opened state, turns on the expansion valve 46, turns off the expansion valve 47, thus forces the air conditioning unit 4 to perform the cooling function (See FIG. 1).

If it is determined by the air cooling instruction portion 64 that the temperature TB detected by the temperature sensor SB is equal to or lower than the preset first threshold temperature SH1, the liquid cooling instruction portion 65 starts the liquid cooling unit 5. In other words, the pump P2 is turned on (See FIG. 1).

If the temperature TB detected by the temperature sensor SB is equal to or lower than a second threshold temperature SH2 (e.g., 18° C.) that is lower than the preset first threshold temperature SH1, the projection instruction portion 66 starts the laser light source 1 and the optical modulation unit 2.

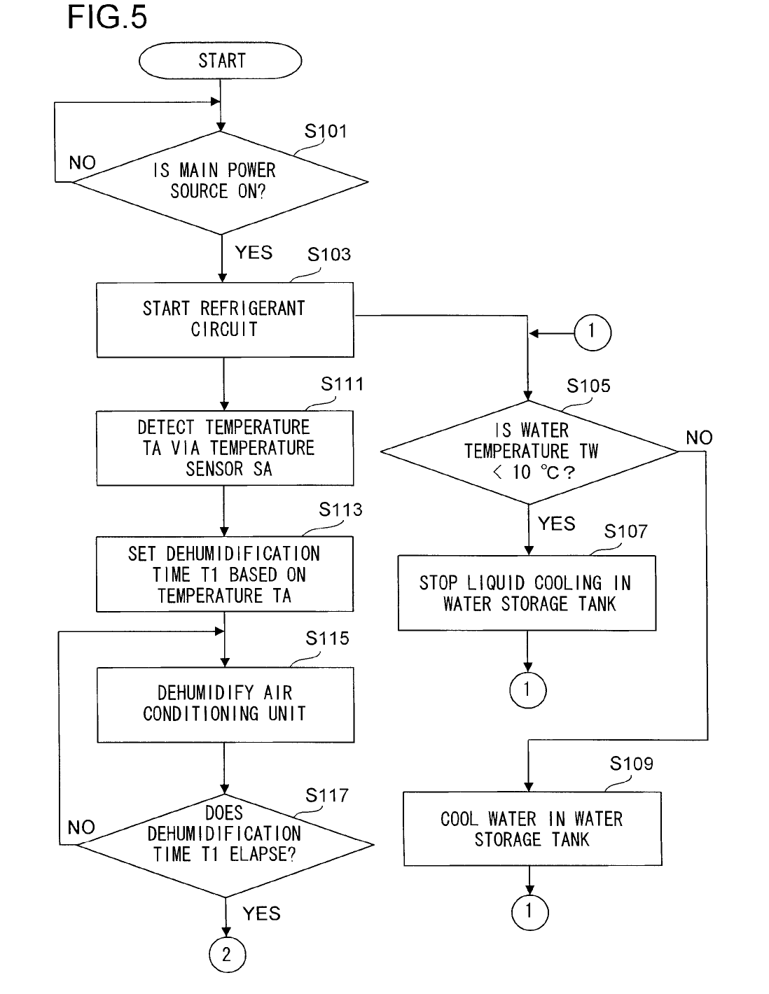

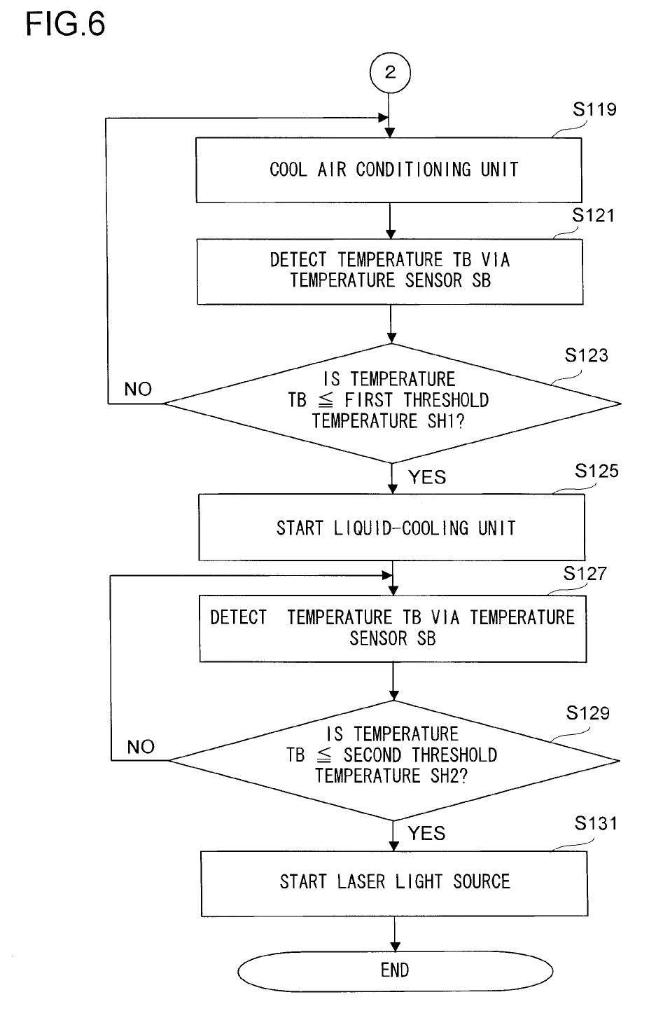

FIG. 5 and FIG. 6 show a flow chart to show an example of operation of the liquid crystal projector 100 (mainly the CPU 6). First, as shown in FIG. 5, it is determined by the dehumidification time set portion 61 whether or not the main power source of the liquid crystal projector 100 is turned on (S101). If it is determined that the main power source is not turned on (NO in S101), the processing is put into a wait state. If it is determined that the main power source is turned on (YES in S101), the refrigerant circuit of the air conditioning unit 4, that is, the compressor 41 and the fans F1 to F3 (See FIG. 1) are started by the initial set portion 62 (S103).

And the cooling-water temperature TW in the water storage tank 51 is detected by the initial set portion 62, and here, it is determined whether or not the temperature TW is lower than 10° C. (S105). If it is determined that the temperature TW is lower than 1020 C. (YES in S105), the expansion valve 48 is closed, the pump P1 is stopped, the cooling of the cooling water is stopped (S107), and the processing is returned to the step S105. If it is determined that the temperature TW is equal to or higher than 10° C. (NO in S105), the expansion valve 48 is turned on, the pump P1 is started, the cooling of the cooling water is begun (S109), and the processing is returned to the step S105.

If the processing in the step S103 is completed, the air temperature TA in the first housing 101 is detected in parallel by the dehumidification time set portion 61 via the temperature sensor SA (S111). Then, the operation time T1 for the dehumidification function of the air conditioning unit 4 is set by the dehumidification time set portion 61 based on the temperature TA detected in the step S111 (S113). Then, the dehumidification operation of the air conditioning unit 4 is performed by the dehumidification instruction portion 63 (S115).

And it is determined by the dehumidification instruction portion 63 in the step S113 whether or not the set operation time T1 elapses (S117). If it is determined that the operation time T1 does not elapse (NO in S117), the processing is returned to the step S115, and the processing following the step S115 is repeatedly performed.

If it is determined that the operation time T1 elapses (YES in S 117), the cooling operation of the air conditioning unit 4 is performed by the air cooling instruction portion 64 (S119) and the temperature TB is detected via the temperature sensor SB (S121). Then, it is determined by the air cooling instruction portion 64 whether or not the temperature TB detected in the step S121 is equal to or lower than the first threshold temperature SH1 (S123). If it is determined that the temperature TB is not equal to nor lower than the first threshold temperature SHE, that is, higher than the first threshold temperature SH1 (NO in S123), the processing is returned to the step S119, and the processing following the step S119 is repeatedly performed.

If it is determined that the temperature TB is equal to or lower than the first threshold temperature SH1 (YES in S123), the liquid cooling unit 5 is started by the liquid cooling instruction portion 65 (S125). And the temperature TB is detected by the projection instruction portion 66 via the temperature sensor SB (S127). Then, it is determined by the projection instruction portion 66 whether or not the temperature TB detected in the step S127 is equal to or lower than the second threshold temperature SH2 (S129). If it is determined that the temperature TB is not equal to nor lower than the second threshold temperature SH2, that is, higher than the second threshold temperature SH2 (NO in S129), the processing is returned to the step S127, and the processing following the step S127 is repeatedly performed until the temperature is lowered by continuation of the operation of the liquid cooling unit 5. If it is determined that the temperature TB is equal to or lower than the second threshold temperature SH2 (YES in S129), the laser light source 1 and the optical modulation unit 2 are started by the projection instruction portion 66 (S131), and the processing is ended.

As described above, because the laser light source 1 and the optical modulation unit 2 that generate video image light to be displayed on a screen are housed in the first housing 101, and because the air in the first housing 101 is dehumidified by the air conditioning unit 4, it is possible to surely prevent performance deterioration of the laser light source 1 from occurring with a simple structure.

In other words, because the air in the first housing 101 in which the laser light source 1 is housed is dehumidified by the air conditioning unit 4, it is possible to prevent water drops due to moisture condensation from attaching to the laser light source 1 and also possible to surely prevent performance deterioration of the laser light source 1 from occurring with a simple structure. Besides, because the air conditioning unit 4 is disposed below the laser light source 1 and the optical modulation unit 2, even if the refrigerant or the lubricating oil leaks from the air conditioning unit 4, it is possible to prevent the refrigerant and the lubricating oil from flowing down to the laser light source 1 and the like and also possible to prevent failure of the laser light source 1 and the like from occurring. Because the air conditioning unit 4 has the cooling function to cool the air in the first housing 101 in which the laser light source 1 is housed, it is possible to control the temperature of the laser light source 1 and also possible to surely prevent performance deterioration of the laser light source 1 from occurring. In addition, because the air conditioning unit 4 is composed of the refrigerant circuit that includes the compressor 41 and both dehumidification and cooling of the air in the first housing 101 are performed at the same time, it is possible to efficiently dehumidify and cool the air in the first housing 101 with a simple structure by only changing the operation states of the heat exchangers 44, 45, that is, by forcing the heat exchangers 44, 45 to operate as heat absorbers or heat radiators.

Because the laser light source 1 and the optical modulation unit 2 are water-cooled by the liquid cooling unit 5 that shares the refrigerant circuit with the air conditioning unit 4, it is possible to realize the liquid cooling unit 5 with a simple structure. Because the laser light source 1 and the optical modulation unit 2 are water-cooled by the liquid cooling unit 5, it is possible to efficiently cool the laser light source 1 and the optical modulation unit 2 and also possible to surely prevent performance deterioration of the laser light source 1 from occurring. Moreover, because the air temperature in the first housing 101 is detected by the temperature sensor SA and because the starts of the air conditioning unit 4, the laser light source 1, the optical modulation unit 2 and the liquid cooling unit 5 are controlled based on the detection result from the temperature sensor SA, it is possible to surely prevent performance deterioration of the laser light source 1 from occurring.

For example, if it is detected by the temperature sensor SA that the air temperature TA in the first housing 101 is high, the air is cooled by the air conditioning unit 4, then the laser light source 1 and the optical modulation unit 2 are started, thus it is possible to surely prevent performance deterioration of the laser light source 1 from occurring. In addition, because the temperature sensor SA detects the air temperature in the first housing 101, it is possible to surely prevent performance deterioration of the laser light source 1 from occurring with a simpler structure. Besides, at the time the power source is turned on, the operation time T1 for the dehumidification function of the air conditioning unit 4 is set based on the air temperature TA detected by the temperature sensor SA; from the time the power source is turned on, the dehumidification function of the air conditioning unit 4 is operated for the set operation time T1; after the operation of the dehumidification function of the air conditioning unit 4 is completed, the laser light source 1 and the optical modulation unit 2 are started; accordingly, it is possible to prevent more surely performance deterioration of the laser light source 1 from occurring.

Because the temperature TB of the laser light source 1 is detected by the temperature sensor SB, and because the starts of the air conditioning unit 4, the laser light source 1, the optical modulation unit 2 and the liquid cooling unit 5 are controlled based on the detection result from the temperature sensor SB, it is possible to prevent more surely performance deterioration of the laser light source 1 from occurring. For example, if it is detected by the temperature sensor SB that the temperature of the laser light source 1 is high, the air is cooled by the liquid cooling unit 5, then the laser light source 1 and the like are started, thus it is possible to more surely prevent performance deterioration of the laser light source 1 from occurring.

Moreover, after the dehumidification function of the air conditioning unit 4 is operated for the set operation time T1, the cooling function of the air conditioning unit 4 is operated until the temperature of the laser light source 1 detected by the temperature sensor SB reaches the preset first threshold temperature SH1 or lower. And if it is determined that the temperature TB of the laser light source 1 detected by the temperature sensor SB reaches the preset first threshold temperature SH1 or lower, the liquid cooling unit 5 is started; if the temperature TB of the laser light source 1 detected by the temperature sensor SB is equal to or lower than the preset second threshold temperature SH2 that is lower than the first threshold temperature SH1, the laser light source 1 and the like are started; accordingly, it is possible to prevent more surely performance deterioration of the laser light source 1 from occurring.

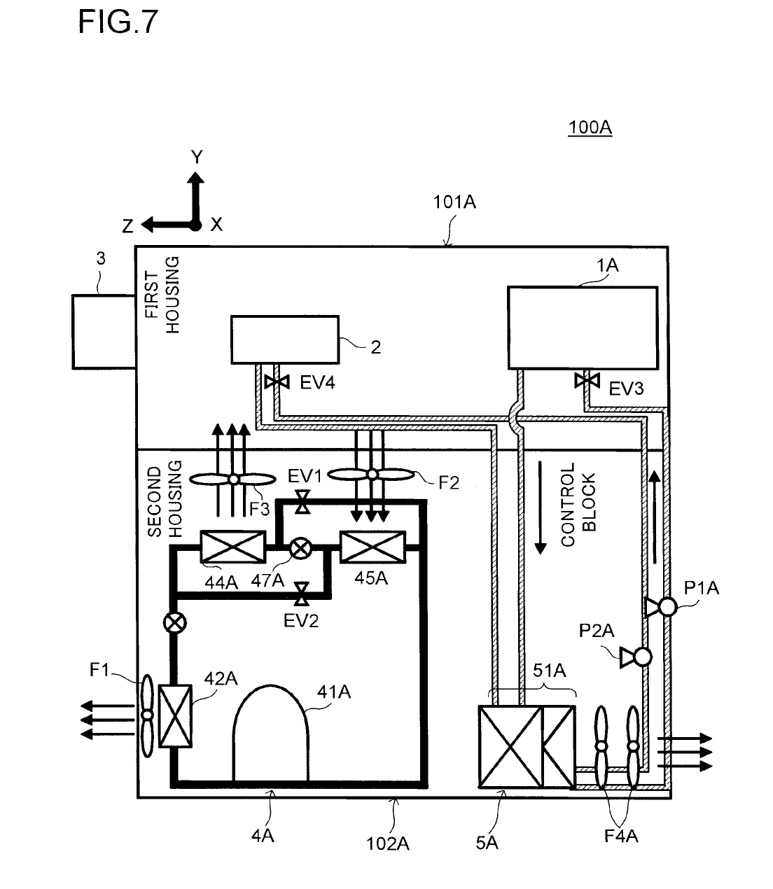

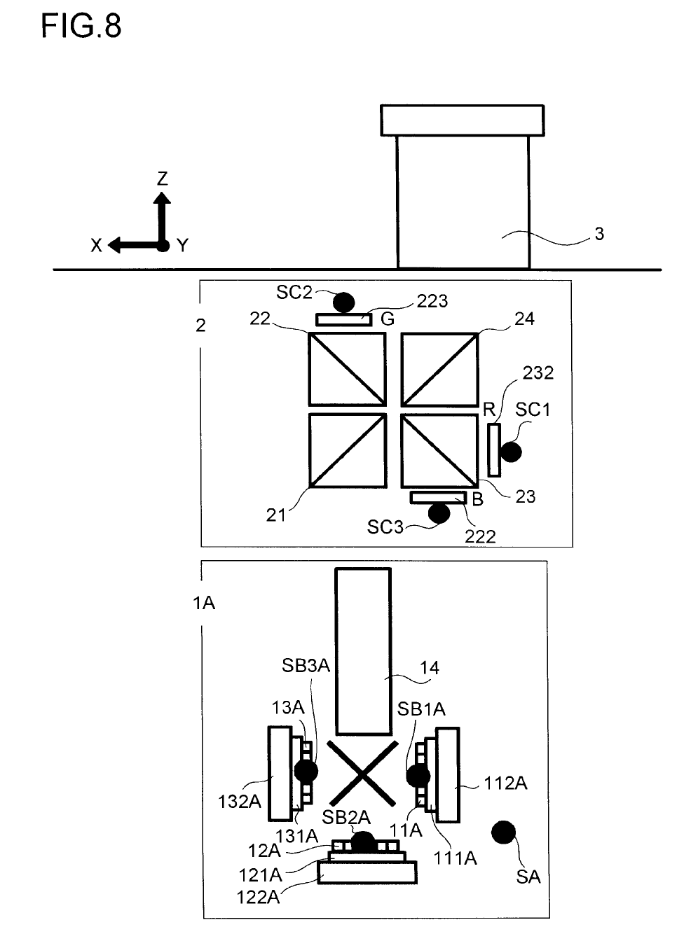

Besides, if it is determined that the temperature TB of the laser light source 1 detected by the temperature sensor SB is equal to or lower than the preset first threshold temperature SH1, the liquid cooling unit 5 is started; if the temperature TB of the laser light source 1 detected by the temperature sensor SB is equal to or lower than the preset second threshold temperature SH2 that is lower than the first threshold temperature SH1, the laser light source 1 and the like are started; accordingly, it is possible to lower the temperature of the laser light source 1 to an appropriate temperature by setting the second threshold temperature SH2 to an appropriate value; thus, it is possible to prevent more surely performance deterioration of the laser light source 1 from occurring.

[Second Embodiment] In the first embodiment, it is described that cooling portion is the liquid cooling unit 5. However, the cooling portion may cool the laser light source 1 with another method. An embodiment in which the cooling portion includes a Peltier element is described by using FIGS. 7, 8. FIG. 7 is a side structural view to show an example of another structure different from the liquid crystal projector according to the present invention in FIG. 1. FIG. 8 is a plan structural view to show an example of another structure different from the laser light source in FIG. 2. In the following description, only points different from the structures that are described by using FIGS. 1, 2 are described, and common points are indicated by the same reference numbers and the description is skipped.

As shown in FIG. 7, an air conditioning unit 4A is different from the air conditioning unit 4 shown in FIG. 1 in that the air conditioning unit 4A does not include the heat exchanger 43 and the expansion valve 48. In other word, the air conditioning unit 4A does not have the cooling function to cool the cooling water that is the heat carry medium of the liquid cooling unit 5. A liquid cooling unit 5A is different from the liquid cooling unit 5 shown in FIG. 1 in that the liquid cooling unit 5A includes a radiator 51A and a fan F4A instead of the water storage tank 51. The radiator 51 A air-cools the cooling water that is the heat carry medium of the liquid cooling unit 5A. According to this structure, as a compressor 41A of the air conditioning unit 4A, it is possible to use a compressor that has a small capacity compared with the compressor 41 of the air conditioning unit 4 shown in FIG. 1.

As shown in FIG. 8, a laser light source 1A is different from the laser light source 1 shown in FIG. 2 in that Peltier elements 111A, 121A, 131A and piping 112A, 122A, 132A for the cooling water from the liquid cooling unit 5A are disposed on rear sides of laser arrays 11A, 12A, and 13A, respectively. Besides, a temperature sensor SBA (which corresponds to a second detection portion) is different from the temperature sensor SB shown in FIG. 2 in that the temperature sensor SBA includes 3 temperature sensors SB1A to SB3A which are respectively disposed near the laser arrays 11A, 12A, 13A and composed of a thermistor and the like. The Peltier elements 111A, 121A, and 131A respectively absorb heat from the laser arrays 11A, 12A, and 13A and radiate the heat to the piping 112A, 122A, and 132A. According to this structure, because the heat from the laser arrays 11A, 12A, and 13A is absorbed via the Peltier elements 111A, 121A, and 131A, it is possible to rapidly cool the laser arrays 11A, 12A, and 13A.

The present invention is applicable to following embodiments as well.

[A] In the above embodiments, it is described that the optical modulation unit generates (modulates) video image light via the reflection type liquid crystal panel. However, the optical modulation unit may generate (modulate) video image light via a transmission liquid crystal panel and may use a DMD (Digital Mirror Device).

[B] In the above embodiments, it is described that the first detection portion is a temperature sensor that detects the air temperature in the first housing. However, the first detection portion is a humidity sensor that detects the air humidity in the first housing. In this case, the dehumidification time set portion is able to set the operation time T1 for the dehumidification function of the air conditioning unit to a more appropriate time.

[C] In the above embodiments, it is described that the dehumidification instruction portion forces the dehumidification function of the air conditioning unit to operate for the operation time set by the dehumidification time set portion. However if the first detection portion is a humidity sensor that detects the air humidity in the first housing, the dehumidification function may be operated until the air humidity in the first housing detected by the first detection portion reaches a preset threshold humidity or lower.

[D] In the above embodiments, it is described that the CPU functionally includes: the dehumidification time set portion; the initial set portion; the dehumidification instruction portion; the air cooling instruction portion; the liquid cooling instruction portion; and the projection instruction portion. However, at least one function portion of the dehumidification time set portion, the initial set portion, the dehumidification instruction portion, the air cooling instruction portion, the liquid cooling instruction portion, and the projection instruction portion may be composed of hardware such as a circuit and the like.

[E] In the first embodiment, it is described that the second detection portion includes the 6 temperature sensors SB1 to SB6. However, the second detection portion may include the 3 temperature sensors SB2, SB4, and SB6 that are disposed in the downstream side of the cooling-water piping. Usually, the temperatures detected by the temperature sensors SB1, SB3, and SB5 that are disposed in the upstream side of the cooling-water piping are higher than the temperatures detected by the 3 temperature sensors SB2, SB4, and SB6 that are disposed in the downstream side of the cooling-water piping. Accordingly, in this case, it is possible to reduce the number of temperature sensors without decreasing the control accuracy. Besides, of the 3 temperature sensors SB2, SB4, and SB6, only one temperature sensor that detects the highest temperature most possibly may be disposed. In this case, it is possible to further reduce the number of temperature sensors.

What is claimed is:

1. A projection video display device comprising:
a projection video generation portion that has a laser light source and an optical modulation unit that modulates light from the laser light source and generates video image light;
a first housing that houses the projection video generation portion; and
an air conditioning portion that has a dehumidification function to dehumidify air in the first housing.

2. The projection video display device according to claim 1, further comprising a second housing that houses the air conditioning portion, wherein the second housing is disposed below the first housing.

3. The projection video display device according to claim 1, wherein the air conditioning portion has a cooling function to cool the air in the first housing.

4. The projection video display device according to claim 1, further comprising a cooling portion that liquid-cools the projection video generation portion.

5. A projection video display device comprising:
a projection video generation portion that has a laser light source and an optical modulation unit that modulates light from the laser light source and generates video image light;
a first housing that houses the projection video generation portion;
a refrigerant circuit to which a compressor, a heat radiator, an expansion valve, and a heat absorber are connected via a refrigerant piping;
a second housing that houses the refrigerant circuit; and
an air blower portion that sends out air in the first housing into the second housing to perform heat exchange with the heat absorber and sends out the air that undergoes the heat exchange with the heat absorber into the first housing.

6. A method for starting a projection video display device that comprising:
a projection video generation portion that has a laser light source and an optical modulation unit that modulates light from the laser light source and generates video image light; and
a first housing that houses the projection video generation portion, wherein the projection video display device, further comprising:
a first detection portion that detects temperature or humidity in the first housing; and
an air conditioning portion that has a function to dehumidify air in the first housing, and wherein
starts of the air conditioning portion and the projection video generation portion are controlled based on detection result from the first detection portion.

7. The method for starting the projection video display device according to claim 6, comprising:
a dehumidification step of operating the dehumidification function of the air conditioning portion for operation time that is set based on detection result detected by the first detection portion; and
a projection step of starting the projection video generation portion after the dehumidification step is completed.

8. The method for starting the projection video display device according to claim 7, wherein the projection video display device further comprising:
a second detection portion that detects temperature of the laser light source; and
a cooling portion that liquid-cools the projection video generation portion, wherein the method further comprising a cooling step of starting the cooling portion if the temperature detected by the second detection portion is equal to or lower than a first preset threshold temperature.
